(19) United States
(12) Patent Application Publication
(10) Pub. No.: US 2006/0244972 A1
(43) Pub. Date: Nov. 2, 2006

(54) Method and assembly for measuring a dispersion in transparent media

(76) Inventor: Adolf Friedrich Fercher, WIEN (AT)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/543,449

(22) PCT Filed: Dec. 16, 2003
(86) PCT No.: PCT/EP03/14279

§ 371 Date: Jul. 11, 2006

(30) Foreign Application Priority Data
Jan. 23, 2003 (DE) 103 02 849.8

(51) Int. Cl. G01B 11/02

(52) U.S. Cl. 356/497; 356/511

(57) ABSTRACT

Spatially localized dispersion measurement and glucose measurement by means of optical short-coherence interference refractometry. This application is directed to methods and arrangements for the measurement of the dispersion and of the glucose content in transparent and partially transparent tissues and body fluids. Methods of short-coherence interferometry and spectral interferometry are modified for the measurement of tissue thickness and for the measurement of local dispersion. In the technique based on short-coherence interferometry, partial interferograms from the short-coherence interferogram G(τ) are used for the dispersion measurement. In the technique based on spectral interferometry, partial areas from the ω-spectrum of the spectral interferogram are used for the dispersion measurement. FIG. 6 shows an arrangement based on spectral interferometry. A temporally short-coherence light source illuminates the modified Michelson interferometer. The beam splitter splits the illuminating beam into a measurement beam and a reference beam. The light waves and reflected from the interferometer impinges on the spectrometer at the interferometer output. The registered spectral interferogram i(ω) forms the basis for the calculation of the dispersion of different orders. The viewing direction of the eye of the subject is fixated by means of a target beam.

### CROSS-REFERENCE TO RELATED APPLICATIONS

This application claims priority of International Application No. PCT/EP2003/014279, filed Dec. 16, 2003 and German Application No. 103 02 849.8, filed Jan. 23, 2003, the complete disclosures of which are hereby incorporated by reference.

### BACKGROUND OF THE INVENTION

a) Field of the Invention

The present invention is directed to methods and arrangements for measuring dispersion and for determining the concentration of substances which are contained in media such as tissues and aqueous solutions and which influence the dispersion. The arrangements described herein are suitable for spatially localized measurement of the dispersion of different orders in transparent and partially transparent tissues and body fluids, particularly in the aqueous humor of the human eye. The value of concentrations, e.g., of glucose, contained therein can be determined from this dispersion measurement.

b) Description of the Related Art

A question that has still not been researched in many respects is that of the dynamics of the glucose content in various body tissues, particularly of the eye. The solutions proposed herein also allow fast quantitative determination of the glucose content in transparent and semitransparent tissues. A completely noninvasive method for determining blood sugar in diabetics is provided in this way.

In diabetes, especially in diabetes mellitus, optimal adjustment of the blood sugar level is a prerequisite for the prevention of secondary diseases. Only diabetics who regularly monitor their metabolic readings can delay or even prevent late complications. The blood sugar level in humans is normally between 50 mg/dl and a maximum of 140 mg/dl (after eating). The aim of diabetes therapy is to approach these blood sugar levels as nearly as possible.

The current standard blood sugar measurement based on glucose oxidation requires drawing blood from the body and is accordingly an invasive process. Even so, this method is severely limited due to fear of self-injury and pain. This can lead to problems particularly in diabetic children whose parents must perform the measurement. Also, diabetics often fail to take measurements that must be carried out in public places under some circumstances. In older patients, blood sugar measurement can often no longer be carried out at all with conventional methods due to calluses on the finger tips and deficient circulation.

According to the known prior art, there are some partially invasive procedures such as iontophoresis (e.g., GlucoWatch by Cygnus) which require only a slight injury (abrasion) to the epidermis. These methods are disadvantageous because they require close contact with the skin without any interference whatsoever (even perspiration) and because of the time delay caused by the skin.

Most noninvasive methods work optically (see R. J. McNichols and G. L. Coté, “Optical glucose sensing in biological fluid: an overview”, Journal of Biomedical Optics (2000) 5(1): 5-16, 2000). These include methods that are based on NIR transmission and reflection or on light reflections and which use polarimetry and Raman spectroscopy. Further, dispersed light methods based on OCT, methods based on IR emissions spectrometry, and photoacoustic methods have been described (Zuomin-Zhao and R. Myllyla, “Photoacoustic determination of glucose concentration in whole blood by a near-infrared laser diode”, Proc. SPIE 4256, 77-83, 2001). However, none of these noninvasive methods has been applied so far. The reason for this is the insufficient sensitivity of the methods, excessive scattering of the measurements or overly complicated application for the patients.

A fundamental method for measuring dispersion of different orders in transmission was described by van Engen et al. in 1998 (A. G. van Engen, S. A. Diddams, and T. S. Clement, “Dispersion measurements of water with white-light interferometry”, Applied Optics 37(24), 5679-5686, 1998). In a first step, the interferogram G(τ) generated by the measurement sample, e.g., in the measurement arm of a Michelson interferometer, is recorded and subjected to a Fourier transformation and gives I(ω)=S(ω)exp[ik(ω)d]. A polynomial fit to the phase values k(ω)·d forms the basis for determining the dispersions of different orders as terms of a Taylor series. The method of van Engen et al. works with transmitted light and requires cuvettes of a known depth. Therefore, a method of this kind is not applicable on the eye.

### OBJECTS AND SUMMARY OF THE INVENTION

It is the primary object of the present invention to develop a technical solution for noninvasive determination of the concentration of substances in transparent or partially transparent ocular fluids or tissues, particularly of the concentration of glucose.

This object is met, according to the invention, in a method for measuring thickness and dispersion of transparent or partially transparent tissue or body fluids through the application of short-coherence interferometry comprising the further step of determining the content of substances which are contained in said transparent or partially transparent tissue or body fluids and which influence optical characteristics from the results of the dispersion measurement.

Further, in accordance with the invention, an arrangement is encompassed for measuring thickness and dispersion of transparent and partially transparent tissues and body fluids, comprising a short-coherence interferometer and a calculating unit serving as an evaluating unit for determining the content of substances which are contained therein and which influence the optical characteristics.

The methods and arrangements described herein provide reliable and accurate measurements and are simple and convenient to use. The solutions are based on the measurement of the dispersion of the aqueous humor of the eye. The measurement merely requires a glance into the target beam exiting from the instrument and a press of the button for triggering the measurement. The subject matter of the application relates to two different arrangements for measuring the dispersions and the glucose content in ocular tissues and/or other semitransparent substances. Since the suggested solutions work with reflected light, the depth of the compartments detected by the measurement, e.g., the cornea thickness and the anterior chamber depth, can be measured in addition.

The invention will be described in the following with reference to different embodiment examples.

### BRIEF DESCRIPTION OF THE DRAWINGS

In the drawings:

FIG. 1 illustrates the optical principle of the short-coherence interferometer for dispersion measurement and glucose measurement;

FIG. 2 shows a series of partial interferograms of ocular interfaces;

FIG. 3 shows the spectral interferogram for a light-reflecting location;

FIG. 4 shows an empirical calibration graph for the glucose concentration;

FIG. 5 shows the signal of a calibrating interferometer;

FIG. 6 shows the optical principle of the spectral interferometer for dispersion measurement and glucose measurement; and

FIG. 7 shows the use of a glucometer according to the invention.

### DESCRIPTION OF THE PREFERRED EMBODIMENTS

The arrangements and methods described in the following combine short-coherence length measurement with short-coherence dispersion measurement and are suitable for in vivo measurements of the eye. The basic physical methods are:
short-coherence interferometry; and
spectral interferometry.

These methods are known as time domain LCI and Fourier domain LCI (see the article by A. F. Fercher and C. K. Hitzenberger, “Optical Coherence Tomography”, Progress in Optics, Vol. 44 (2003), Chapter 4, E. Wolf (ed). In contrast to the methods and arrangements of short-coherence length measurement described in the above-cited reference, the proposed solutions make it possible to measure not only the lengths of the compartments but also their dispersions. The measurement of the dispersions and of the glucose content following therefrom in compartments such as tissues and aqueous solutions, e.g., the aqueous humor of the human eye, are substantial components of the present solution. Compared to the previous methods of interference refractometry, the arrangements and methods proposed herein measure not only the dispersion of the beam-penetrated media but also their thickness. The solutions according to the invention are based on two different measurement beam paths and the accompanying two calculation methods.

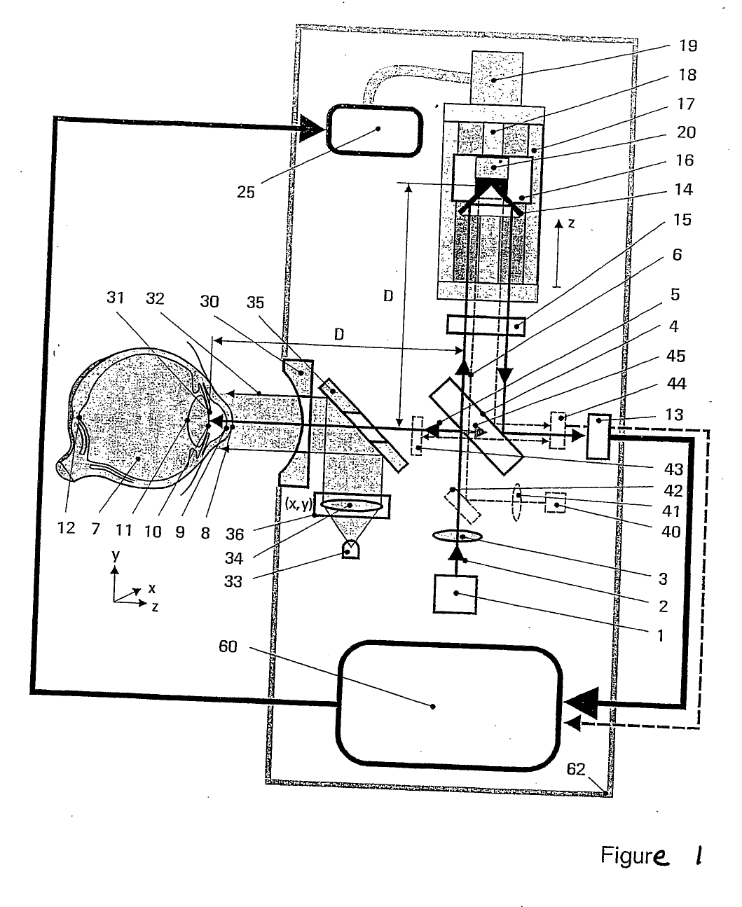

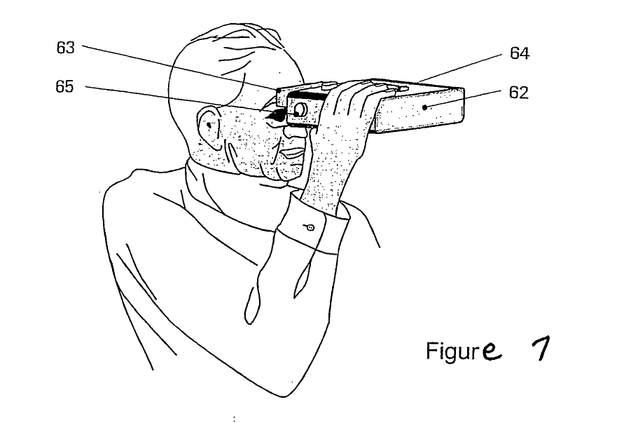

The technologies of short-coherence correlation interferometry and spectral interferometry that serve as basis result in two different measurement beam paths (according to FIGS. 1 and 6). In both cases, the sample is located in one arm of a two-beam interferometer, e.g., of a Michelson interferometer. Whereas in short-coherence correlation interferometry the reference mirror 14 of the interferometer is moved for receiving the interferogram at the interferometer output, the reference mirror 14 remains stationary when measuring by spectral interferometry. A triple mirror or triple prism is preferably used as reference mirror 14. The light bundle exiting at the interferometer output is analyzed by a spectral photometer. Following several intermediate steps, both methods supply the frequency-dependent transfer function of the sample from whose phase terms the dispersions of the sample substance are calculated. The individual steps of the two calculation methods and the two measurement arrangements will be described in detail in the following.

1. Calculation Methods

1.1 Length Measurement and Dispersion Measurement by Means of Short-Coherence Correlation Interferometry

1.1.1 Length Measurement

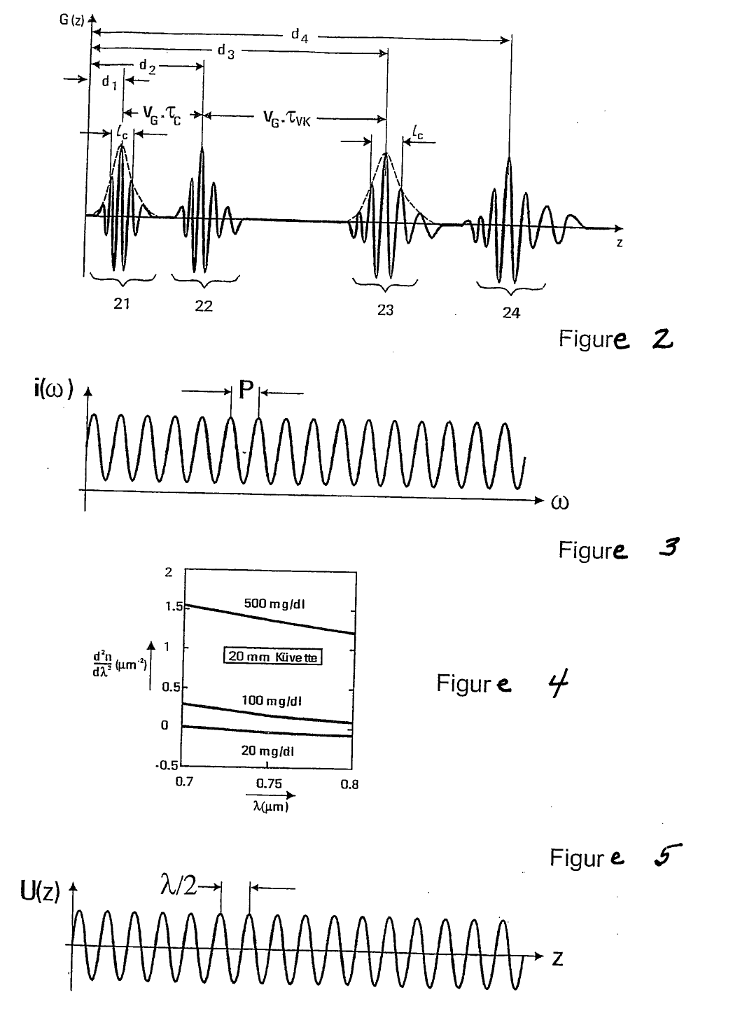

A continuously changed optical path difference L between the reference beam and measurement beam and, therefore, an interferogram G(τ) depending on the running time difference T are produced at the interferometer output by a reference mirror which is, e.g., continuously displaced. The running time difference τ=L/c is the time delay occurring between the partial beams of the interferometer. G(τ) is a signal as is illustrated in FIG. 2. The thickness of the compartments is given by the spacing of the partial interferograms 21, 22, and so on (up to 24 in our embodiment example) as is conventional in short-coherence correlation interferometry.

1.1.2 Measurement of Dispersion

According to the invention, the isolated partial interferograms 21 to 24 are obtained from the spatially dependent dispersion values. Initially, complex partial interferogram spectra I₂₁(ω), I₂₂(ω), and so on, are obtained through Fourier transformation. The partial interferogram spectra I₂₁(ω), I₂₂(ω), and so on, have spectral phases Φ₂₁(ω)=2 k(ω)d₁, Φ₂₁(ω)=2 k(ω)d₂, and so on, from which expressions for the derivations of the wave numbers k(ω) are obtained according to van Engen et al. (1998) after a polynomial fit carried out selectively beforehand, e.g., with Zemike polynomials: The sth derivations of the wave numbers k(ω)

$$\frac{{ⅆ}^{s} k}{ⅆ {ω}^{s}}$$

determined from the partial interferograms 21, 22, and so on, are the sth-order dispersions for distances d₁, d₂, and so on.
1.2 Length Measurement and Dispersion Measurement by Means of Spectral Interferometry
1.2.1 Length Measurement

First, the spectral interferogram i(ω) occurring at the interferometer output with fixed reference mirror is recorded. For individual light-reflecting points in the measurement object, the intensity shape of this interferogram in the spectral plane 70 of the spectrometer has a period length P in the ω-space that is indirectly proportional to the distance of this point from the virtual position of the reference mirror (reflected at the beam splitter of the interferometer; see FIG. 3). The complex interferogram I(ω) is given by means of a Hilbert transformation of i(ω). A Fourier transformation gives the interferogram G(τ) and therefore also the partial interferograms and the thicknesses of the compartments as was described above under heading 1.1.1.

1.2.2 Dispersion Measurement

As was described under heading 1.1.2, the dispersion can be calculated in principle based on the partial interferograms. However, because of the small quantity of sampling values per partial interferogram, this would deliver low sensitivity and low accuracy. Greater sensitivity is achieved when proceeding according to the invention as follows: Depending upon the distance of the light-reflecting point in the eye, the interferogram spectrum I(ω) contains light components with period lengths P of different sizes in the ω-space. Corresponding to the sampling theorem, the sampling must be carried out at a spatial frequency that is high enough so that aliasing does not occur. This is the case, according to the rules of spectral interferometry, when

$$N = \frac{2 Δ k}{π} {z}_{S}$$

sampling values are recorded, where

$$Δ K = \frac{2 Δω}{c}$$

is the dispersion vector, Δω is the frequency bandwidth of the light, and zₛ is the maximum distance of a light-reflecting measurement object point from the virtual position of the reference mirror (reflected by the beam splitter surface of the interferometer).

As can be seen in FIG. 3, the reflection points at the greatest distance from the reference mirror include the smallest period lengths P in the intensity spectrum and, therefore, the greatest 1/P frequencies in the intensity curve in the spectral plane 70. This frequency is referred to as the 1/P frequency to avoid confusion with the light frequency ω. Therefore, the sampling in the spectral plane 70 must be carried out in such a way that the sampling theorem is met for the reflection points virtually at the greatest distance from the reference mirror position because, otherwise, displacement of signal components along the measurement path would result due to the aliasing phenomenon. For purposes of measurement, the reference mirror is positioned in such a way that its virtual position comes as close as possible to that measurement object position (e.g., at the eye, the anterior lens surface) where the dispersion is to be determined. This includes the lowest 1/P frequencies in the intensity curve in the spectral plane 70 or the greatest period lengths P. After sampling, the higher 1/P frequencies in the intensity curve in the spectral plane 70 are eliminated mathematically. The dispersions are determined, according to the invention, from the phase Φ(ω)=k(ω)d of the remaining 1/P low-pass spectrum in the intensity curve in the spectral plane 70. This gives the dispersions at the interface coming closest virtually to the reference mirror.

2. Arrangements

2.1 Short-Coherence Correlation Interferometry

The optical principle of the short-coherence interferometer is illustrated in FIG. 1. A temporally short-coherence light source 1, e.g., a superluminescent diode or a multimode laser, an LED, a plasma light source, a halogen lamp or an incandescent lamp, emits a short-coherence light beam 2 that is collimated by optics 3 in the modified Michelson interferometer with the beam splitter 4. The beam splitter 4 splits this beam into a measurement beam 5 and a reference beam 6. The measurement beam 5 strikes the eye 7 and is reflected back from its interfaces, e.g., the anterior corneal surface 8, the posterior corneal surface 9, the anterior lens surface 10, the posterior lens surface 11, and the fundus 12. The reflected light waves 45 traverse the interferometer and impinge on the photodetector 13. The reference beam 6 is reflected by the triple prism 14, transmitted through the plane plate 15 (a second time) and is reflected by the rear surface of the beam splitter 4 to the photodetector 13, where it undergoes interference with the waves 45 reflected by the eye 7.

In order to record the interferogram G(τ), the reference mirror 14 is moved by means of a scanning device comprising a carriage or slide 16, guide 17, drive spindle 18 and motor 19. This entails a Doppler displacement of the reflected reference wave. The interferogram G(τ) is obtained from the photoelectric signal of the detector 13 by frequency band filtering at the Doppler frequency. When the optical distances in the measurement beam 5 and the reference beam 6 within the coherence length are equal, as is indicated, e.g., in FIG. 1 by distance D for the anterior lens surface 10, a photoelectric AC signal occurs at this Doppler frequency as is indicated in FIG. 2 by partial interferogram 23. The z-coordinate in FIG. 2 is linked to the τ coordinate by the velocity v of the reference mirror 14: τ=2 z/c and z=ν·t, where l_{c} is the coherence length. G(z) contains a series of partial interferograms according to FIG. 2, where 21 is the interferogram of the wave reflected by the anterior corneal surface 8 with reference wave 6; 22 is that of the wave reflected by the posterior corneal surface 9 with reference wave 6; 23 is that of the wave reflected by the anterior lens surface 10 with reference wave 6, and 24 is that of the wave reflected by the posterior lens surface 11 with reference wave 6. The interferogram of the wave reflected by the fundus 12 with reference wave 6 is not shown. These interferograms are also described in physics as interference of wave groups reflected at the interfaces with those of the reference arm. FIG. 2 illustrates the dispersion-dependent increase in the coherence length l_{c} along the abscissa and a change in the signal shape of these wave groups.

The dispersion-dependent change in the partial interferogram G(z) shown in FIG. 2 is the basis for the dispersion measurement and glucose measurement presented herein. Therefore, the points at which the partial interferograms originate in the measurement object are possible positions for the measurement of dispersion. The first-order dispersion, i.e.,

$$\frac{ⅆ k}{ⅆ ω} ,$$

causes a group velocity that differs from the phase velocity c of the light:

$${v}_{G} = {[ {( \frac{ⅆ k ( ω )}{ⅆ ω} )}_{{ω}_{0}} ]}^{- 1} = \frac{c}{{n}_{G}} , k ( ω ) = \frac{2 π}{λ}$$

is the wave number, ω₀=2πν₀ at the average frequency ν₀ of the light wave,

$${n}_{G} = n - λ \frac{ⅆ n}{ⅆ λ}$$

is the group index, n is the refractive index. The second-order dispersion is

$$\frac{{ⅆ}^{2} k}{ⅆ {ω}^{2}} = \frac{1}{2 π} \frac{c}{{v}^{3}} \frac{{ⅆ}^{2} n}{ⅆ {λ}^{2}} ;$$

this changes the coherence length and the shape of the partial interferograms. Since the spectral shape of the refractive index n is determined by the polarizability of the molecules of the medium, these and its sth differential quotient

$$\frac{{ⅆ}^{s} n}{ⅆ {λ}^{s}}$$

are characteristic of the types of molecules transmitting the light. Thus, the spectral shape of n(λ) and the spectral shape of the sth differential quotient

$$\frac{{ⅆ}^{s} n ( λ )}{ⅆ {λ}^{s}}$$

can be used for characterization of this kind.

It has been shown that the glucose content in aqueous solutions can already be determined by using the second-order dispersion

$$( ∝ \frac{{ⅆ}^{2} n}{ⅆ {λ}^{2}} )$$

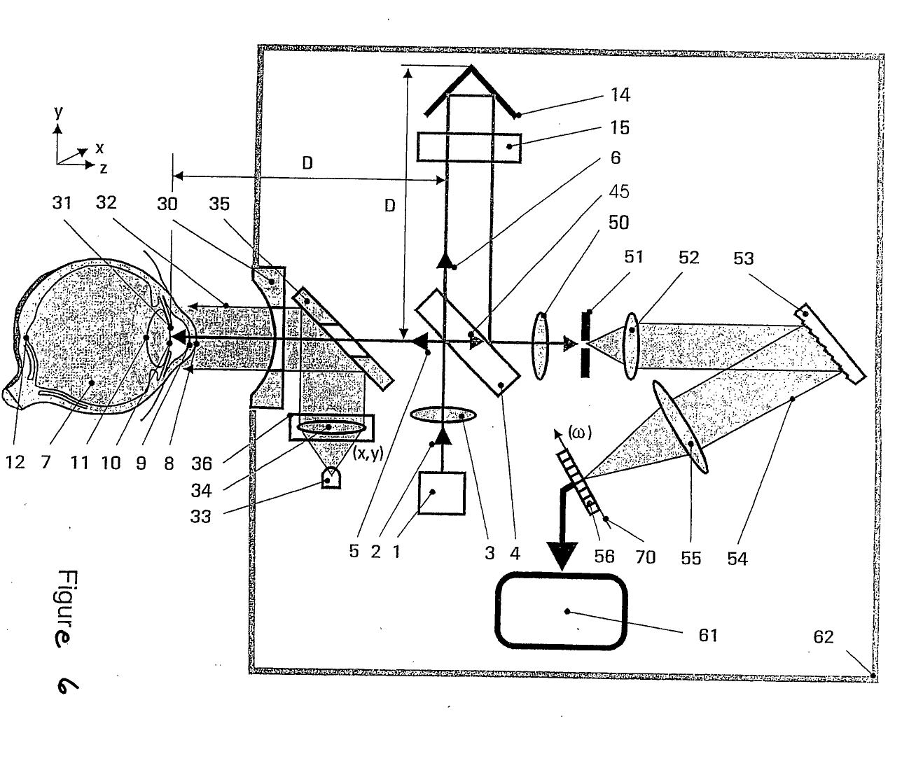

with a sensitivity of the magnitude of the physiologically relevant values (Liu et al., Proc. SPIEE 2003). A corresponding preliminary calibration graph is shown in FIG. 4. The method can be made even more sensitive and precise by means of special broadband light sources and by including the spectral values of the first-order dispersion, the spectral values of the third-order dispersion, and the spectral index of refraction.

It is useful to compensate the dispersion in the measurement arm up to the position of the dispersion measurement with an equal dispersion in the reference arm so as not to burden the data recording and data processing with instrument-dependent dispersion. In order to compensate for the influence of the water on the dispersion of the aqueous humor when measuring dispersion at the eye, a cuvette filled with water can be arranged in the reference beam, wherein the water length corresponds to that of the chamber depth plus the cornea thickness. Because of the high water content of the cornea, the latter can be included in the dispersion compensation for water. Instead of the cuvette filled with water, a plane plate 15 of glass can also be arranged in the reference beam corresponding to FIG. 1. This must generate the same dispersion as the 3.6-mm section between the corneal vertex and the anterior lens vertex (Gullstrand eye). For BK 7 and the second-order dispersion, this is the case for λ=0.5 μm to λ=0.8 μm, e.g., at a thickness of around 2.3 mm. Then, ideally, only the effect of the dispersion generated by the dissolved substance, e.g., glucose, remains in the interferogram.

The dispersion effect of the glucose is proportional to its concentration in the aqueous humor and to the depth of the anterior chamber. Therefore, in order to determine the aqueous humor glucose, the depth of the anterior chamber and the thickness of the cornea must be known. These thicknesses correspond to the distances between interferograms 21 and 22 and interferograms 22 and 23. The corneal thickness is τ_{C}·ν_{GC}, the depth of the anterior chamber is τ_{VK}·ν_{GVK}, where ν_{GC} and ν_{GVK} are the group velocities in the cornea and in the anterior chamber.

The interferogram 23 of the anterior lens surface 10 contains the information about the anterior chamber glucose. A very short movement of the reference mirror 14 suffices to acquire the interferogram 23 of the anterior lens surface 10; in principle, a distance of several coherence lengths is sufficient. Depending on the bandwidth of the light source 1, this is several micrometers to several tens of micrometers. Therefore, in addition to the short-coherence depth scan (also called A-scan in the literature) which is carried out by the slide 16, a short scan mode for the reference mirror is also provided for this dispersion measurement, wherein the reference mirror is only moved by a short distance, e.g., by ½ mm, virtually centered around the position of the dispersion measurement, e.g., around the position of the anterior lens surface 10. This can be carried out by means of a corresponding electrical short scan mode of the control unit 25 controlling the drive motor 19. A short scan mode of this kind can also be realized in that the reference mirror 14 is fastened to the slide 16 by a piezoelectric adjusting unit 20 by means of which a precise movement by several tens of micrometers to several hundreds of micrometers is carried out with the slide 16 stationary. Instead of the piezoelectric adjustment, the short scan mode can also be realized through an electrodynamic adjustment by means of a so-called “voice coil” or another fine adjustment. It is noted that the short-coherence depth scan itself can be carried out with one of the latter arrangements mentioned above. The short scan mode can also be realized by means of the electric control unit 25 in this case. Finally, the A-scan can also be carried out by means of the delay line described by Kwong et al. in 1993 (K. F. Kwong, D. Yankelevich, K. C. Chu, J. P. Heritage and A. Dienes, “400-Hz mechanical scanning optical delay line”, Opt. Lett. 18(7), 558-560, 1993). In this case, the short scan mode can be realized by means of corresponding electrical control of a tilting mirror.

However, care must be taken in the short scan mode that it is actually also carried out so as to be centered around the position of the dispersion measurement, that is, e.g., of the anterior lens surface 10. This cannot be ensured when the head (in particular, the eye of the test subject) is freely movable relative to the interferometer. Therefore, a forehead support 63 is provided in order to ensure a distance from the instrument that is accurate up to about one half of a millimeter by supporting the head at the measuring instrument (see FIG. 7). Since the anatomical position of the eye 7 with respect to the forehead varies from subject to subject, this forehead support must allow a variable adjustment of the instrument distance. The correct position of the anterior lens surface 10 of the eye 7 and accordingly the position of the iris and entrance pupil are crucial.

Therefore, a device is provided which allows the entrance pupil of the eye 7 to be brought into the same position with respect to the interferometer in a reproducible manner. This device comprises a (pierced) spherical concave mirror 30. The test subject must move his/her eye 7 into a position such that the concave mirror 30 images the entrance pupil 31 of the eye 7 onto itself in a scale of 1:1. This is the case when the subject no longer has any sensitivity to light for the first time while the eye 7 approaches the instrument or when the subject no longer has sensitivity to light for the last time as the eye 7 moves away from the instrument. This process is facilitated by a forehead support 63 with a continuously adjustable distance.

Further, the viewing direction of the eye 7 must be fixed. Care must be exercised in this regard that the visual axis is around 5° to 10° nasally (in direction of the nose) to the imaginary axis of symmetry of the optical system, the optical axis. In order to receive the reflections from the interfaces of the eye 7 in the interferometer beam path, the eye 7 must be correspondingly oriented. This is achieved by means of a target beam 32 which is generated by the point light source 33 and the collimating optics 34 and which is directed to the eye 7 via the pierced deflecting mirror 35. The collimating optics 34 are displaceable in their holder 36 in the x-direction and y-direction, so that different inclinations of the target beam 32 relative to the axis of the measurement beam 5 can be adjusted in this way.

In order to compensate for nonlinearities in the displacement of the reference mirror 14, another calibrating interferometer, shown in dashed lines, is provided. It comprises the light source 40 which, in contrast to the light source 1, is highly coherent temporally, e.g., a monomode semiconductor laser or a helium-neon laser. Further, this calibrating interferometer comprises collimating optics 41, a deflecting mirror 42, an end mirror 43, and the photodetector 44. The beam splitter 4 and the reference mirror 14 of the short-coherence interferometer function as beam splitter and reference mirror. The beam path of the calibrating interferometer is shown in dashed lines in FIG. 1 offset laterally to the beam path of the short-coherence interferometer. However, it actually lies somewhat above or below the beam path of the short-coherence interferometer.

The electric signals supplied by the photodetectors are processed in the calculating unit 60. An abscissa extending strictly linearly with r is important in this connection. However, severe nonlinearities occur in r due to variations in the speed of the reference mirror 14. These nonlinearities are eliminated by means of the photodetector signal of the calibrating interferometer. The calibrating interferometer supplies a periodic signal with a period length of the half-wavelength of its light during the entire displacement of the reference mirror 14 as is illustrated in FIG. 5. The abscissa is accordingly divided into constant segments which can serve as a time base for the synchronously recorded measurement signal and can therefore linearize the time scale of the measurement signal.

2.2 Spectral Interferometry

This optical principle is illustrated in FIG. 6. A temporally short-coherence light source 1, e.g., a superluminescent diode, a multimode laser, an LED, a plasma lamp, an incandescent lamp or a halogen lamp, emits a short-coherence light beam 2 that is collimated by the optics 3 in the modified Michelson interferometer with the beam splitter 4. The beam splitter 4 splits this beam into a measurement beam 5 and a reference beam 6. The measurement beam 5 strikes the eye 7 and is reflected back by its interfaces, e.g., the anterior corneal surface 8, posterior corneal surface 9, anterior lens surface 10, posterior lens surface 11 and fundus 12. These reflected light waves 45 traverse the interferometer and impinge on the spectrometer which comprises the entrance diaphragm 51, collimating optics 52, diffraction grating 53, focusing optics 55 and detector array 56. The reference beam 6 is transmitted through the plane plate 15, reflected by the reference mirror 14, transmitted through the plane plate 15 a second time, and deflected by the back surface of the beam splitter 4 into the entrance diaphragm 51 of the spectrometer, where it undergoes interference with the waves 45 reflected by the eye 7.

In this connection, the spectral interferogram i(ω) recorded by the detector array 56 in the spectral plane 70 forms the basis for the calculation of the sth-order dispersions as was described under heading 1.2.2. The measurement of the intraocular partial distances such as corneal thickness, anterior chamber depth and lens thickness is carried out according to the rules of short-coherence interferometry (Fourier domain LCI, see the above-cited survey article by A. F. Fercher and C. K. Hitzenberger, “Optical Coherence Tomography”, Progress in Optics, Vol. 44 (2003), Ch. 4, E. Wolf (ed). For this purpose, the virtual position of the reference mirror (reflected by the beam splitter surface of the interferometer) must lie at approximately twice the distance of the sum of these partial distances in front of the cornea. The forehead support 63 must therefore be designed in such a way that it allows this distance to be adjusted.

In this connection, it is sensible not to burden the data registration and data processing with device-dependent dispersion and to compensate for the dispersion in the measurement arm with an equal dispersion in the reference arm, for example, by means of a cuvette filled with water or a suitable plane plate 15 of glass or another transparent material with a suitable dispersion.

Since the information about the anterior chamber glucose is contained in the light reflected from the position of the dispersion measurement, that is, e.g., of the anterior lens surface 10, this position should be acquired with maximum resolution. In order to record the Fourier components of the light reflected from the position of the dispersion measurement with a maximum sample rate, the virtual position of the reference mirror (reflected by the splitter surface of the interferometer) must lie as close as possible to the position of the dispersion measurement, in contrast to the already known Fourier domain LCI length measurement technique. For this purpose, a forehead support 63 is provided in order to ensure a distance from the instrument that is accurate up to approximately 1 mm by supporting the head at the measuring instrument. Since the anatomical position of the eye 7 with respect to the forehead varies from subject to subject, the instrument distance must be variably adjustable.

The correct position of the anterior lens surface 10 of the eye 7 is crucial for the measurement of the aqueous humor dispersion; this corresponds to the position of the iris and, therefore, of the entrance pupil 31 of the eye 7. Therefore, a device is also provided in this case which allows the subject to move the entrance pupil 31 of his/her eye 7 into the same position with respect to the interferometer in a reproducible manner. For this purpose, a (pierced) spherical concave mirror 30 is arranged at the measurement window of the interferometer. The test subject must move his/her eye 7 into a position such that the concave mirror 30 images the entrance pupil 31 of the eye 7 onto itself in a scale of 1:1. This is the case when the subject no longer has any sensitivity to light for the first time while the eye 7 approaches the instrument or when the subject no longer has sensitivity to light for the last time as the eye 7 moves away from the instrument. This process is facilitated by a forehead support 63 with a continuously adjustable distance.

Again, the viewing direction of the eye 7 of the subject must be fixed. Again, this is achieved by means of a target beam 32 which is generated by the point light source 33 and the collimating optics 34 and which is directed to the eye 7 of the subject via the (pierced) deflecting mirror 35. The optics 34 are displaceable in their holder 36 in the x-direction and y-direction, so that different inclinations of the target beam 32 relative to the axis of the measurement beam 5 can be adjusted in this way.

3. Glucometer

The calculating methods described under heading 1, are carried out in a calculation unit 60 or 61. The glucose content is determined from the calculated dispersions based on stored empirical tables as shown, e.g., in FIG. 4. FIG. 7 shows the use of an instrument of this kind. For individual glucose monitoring, the entire arrangement, including the calculation unit (60 or 61), can be easily accommodated in a housing 62 which can be held by one hand in front of the eye 7 and supported at the forehead by means of the forehead support 63. A display unit 64 for the glucose content determined from the measured dispersions by means of internally stored tables and rotary knobs 65 for adjusting the target beam 32 are also located at the surface.

It should also be noted that the distance adjustment by means of the forehead support 63 and the adjustment of the target beam 32 for a test subject are made only when the instrument is first used. These adjustments can be omitted in subsequent glucose measurements.

The described methods measure the cumulative dispersion up to the position of the dispersion measurement. Therefore, these methods can be used to measure the dispersions in tissues other than the cornea and aqueous humor, for example, in order to measure the cumulative dispersion in the cornea, aqueous humor and lens, or to measure the cumulative dispersion in the cornea, aqueous humor, lens and vitreous body. However, these methods can also be applied for measuring the dispersions in other tissues and fluids.

In this respect, the position of the reference mirror is crucial. In spectral interferometry, this reference mirror must lie virtually as close as possible to the position of the dispersion measurement so that the low-pass spectrum contains the signal from the position of the dispersion measurement. In short-coherence correlation interferometry, the scan length of the short scan mode must contain the position of the dispersion measurement. The dispersion of individual tissues by themselves, e.g., the dispersion of the eye lens, can also be determined from these measurement values by subtraction.

While the foregoing description and drawings represent the present invention, it will be obvious to those skilled in the art that various changes may be made therein without departing from the true spirit and scope of the present invention.

### REFERENCE NUMBERS

1 light source
2 short-coherence light beam
3 optics
4 beam splitter
5 measurement beam
6 reference beam
7 eye
8 anterior corneal surface
9 posterior corneal surface
10 anterior lens surface
11 posterior lens surface
12 fundus
13 photodetector
14 reference mirror
15 plane plate
16 slide
17 guide
18 drive spindle
19 motor
20 piezoelectric adjusting unit
21 partial interferogram (of 8)
22 partial interferogram (of 9)
23 partial interferogram (of 10)
24 partial interferogram (of 11)
25 control unit
30 spherical concave mirror
31 entrance pupil
32 target beam
33 point light source
34 collimating optics
35 deflecting mirror
36 holder
40 light source
41 collimating optics
42 deflecting mirror
43 end mirror
44 photodetector
45 reflected light waves
51 entrance diaphragm
52 collimating optics
53 diffraction grating
55 focusing optics
56 detector array
60 calculation unit
61 calculation unit
62 housing
63 forehead support
64 display unit
65 rotary knob
70 spectral plane

1-35. (canceled)

36. A method for measuring thickness and dispersion of transparent or partially transparent tissue or body fluids through the application of short-coherence interferometry comprising the further step of determining the content of substances which are contained in said transparent or partially transparent tissue or body fluids and which influence optical characteristics from the results of the dispersion measurement.

37. The method according to claim 36, wherein the content of the contained substances is determined by the use of stored tables.

38. The method according to claim 36, wherein the glucose content is determined from the results of the dispersion measurement by the use of stored tables.

39. The method according to claim 36, wherein only partial interferograms from the short-coherence interferogram G(τ) are used for the dispersion measurement.

40. The method according to claim 36, wherein the dispersion measurement is carried out by a short scan around a preselected point, particularly the virtual position of the dispersion measurement.

41. The method according to claim 36, wherein the dispersion measurement is carried out on the eye by applying short-coherence interferometry.

42. The method according to claim 41, wherein the relative position of a reference mirror with respect to the eye is fixed by a forehead support and is adjusted by a concave mirror.

43. The method according to claim 41, wherein the orientation of the eye relative to the measurement beam of an interferometer is carried out by the use of a target beam.

44. The method according to claim 41, wherein a modified Michelson interferometer is used as interferometer.

45. The method according to claim 41, wherein the movement of the reference mirror is registered by a calibrating interferometer.

46. An arrangement for measuring thickness and dispersion of transparent and partially transparent tissues and body fluids, comprising:
a short-coherence interferometer; and
a calculating unit serving as evaluating unit for determining the content of substances which are contained therein and which influence the optical characteristics.

47. The arrangement according to claim 46, wherein tables for determining the content, in particular of glucose, are stored in the calculating unit.

48. The arrangement according to claim 46, wherein the short-coherence interferometer and the calculating unit which serves as evaluating unit are used for determination at the eye.

49. The arrangement according to claim 48, having an additional control unit and a photodetector for implementing short scans around a preselected location, in particular the virtual position of the dispersion measurement.

50. The arrangement according to claim 48, having a forehead support and a concave mirror for positioning and fixing a reference mirror relative to the eye.

51. The arrangement according to claim 48, having a target device comprising a light source, collimating optics and a deflecting mirror for orientation of the eye relative to the measurement beam of an interferometer.

52. The arrangement according to claim 48, wherein a modified Michelson interferometer is used as interferometer.

53. The arrangement according to claim 48, having a calibrating interferometer for registering the movement of the reference mirror.

54. A method for measuring thickness and dispersion of transparent and partially transparent tissue or body fluids through the application of spectral interferometry, comprising the further step of determining the content of substances which are contained therein and which influence optical characteristics from the results of the dispersion measurement.

55. The method according to claim 54, wherein the content of the contained substances is determined by the use of stored tables.

56. The method according to claim 54, wherein the glucose content is determined from the results of the dispersion measurement by the use of stored tables.

57. The method according to claims 54, wherein only a partial area from the 1/P frequency spectrum of the spectral interferogram is used for the dispersion measurement.

58. The method according to claim 54, wherein only a lowpass-filtered portion of the 1/P spectrum of the spectral interferogram is used for the dispersion measurement,

59. The method according to claim 54, wherein the dispersion measurement is carried out at the eye by applying spectral interferometry.

60. The method according to claim 59, wherein the position of the eye relative to a reference mirror is fixed by a forehead support and adjusted by a concave mirror.

61. The method according to claim 59, wherein the orientation of the eye relative to the measurement beam of an interferometer is carried out by a target beam.

62. The method according to claim 59, wherein a modified Michelson interferometer is used as interferometer.

63. An arrangement for measuring thickness and dispersion of transparent and partially transparent tissue and body fluids, comprising:
a spectral interferometer; and
a calculating unit serving as evaluating unit for determining the content of substances which are contained therein and which influence the optical characteristics.

64. The arrangement according to claim 63, wherein tables for determining the content, in particular of glucose, are stored in the calculating unit.

65. The arrangement according to claim 63, wherein only a lowpass-filtered portion of the 1/P spectrum of the spectral interferogram is used for the dispersion measurement.

66. The arrangement according to claim 63, wherein the spectral interferometer and the calculating unit which serves as evaluating unit are used for determination at the eye.

67. The arrangement according to claim 66, having a forehead support and a concave mirror for positioning and fixing the eye relative to a reference mirror.

68. The arrangement according to claim 67, having a target device comprising a light source, collimating optics and a deflecting mirror for orientation of the eye relative to the measurement beam of an interferometer.

69. The arrangement according to claim 67, wherein a modified Michelson interferometer is used as interferometer.

70. The arrangement according to claim 67, having a calibrating interferometer for registering the movement of the reference mirror.
